(19) United States
(12) Patent Application Publication
(10) Pub. No.: US 2013/0002812 A1
(43) Pub. Date: Jan. 3, 2013

(54) ENCODING AND/OR DECODING 3D INFORMATION

(75) Inventors: Dinkar N. Bhat, Princeton, NJ (US); Yeqing Wang, Horsham, PA (US)

(73) Assignee: GENERAL INSTRUMENT CORPORATION, Horsham, PA (US)

(21) Appl. No.: 13/172,362

(22) Filed: Jun. 29, 2011

(51) Int. Cl. H04N 13/00

(52) U.S. Cl. 348/43; 348/E13.062

(57) ABSTRACT

There is an encoding of three dimensional (3D) information. The encoding may include receiving a signal including frames in a 3D video sequence, receiving caption information to appear in a caption window associated with the frames, and/or receiving disparity information associated with the frames. The encoding may also include determining frame disparity maps based on the disparity information associated with the frames. The frame disparity maps may be determined by dividing a part of a frame into a plurality of grid cells. The grid cells may define a disparity measure associated with locations in a grid. The grid cells may form a caption window disparity map dividable into equivalent size portions including an equivalent amount of grid cells. The encoding may also include encoding the frames, the caption information and the frame disparity maps. There is also a decoding of the 3D information.

### BACKGROUND

Closed captioning is a concept associated with systems and processes to display text on a television, video screen or cinema. It has developed to provide additional or interpretive information to select types of viewers, such as viewers having a hearing impairment. The term “closed captions” often refers to a user viewing feature of displayed caption text. Caption information is typically a display of a transcription of an audio portion of a program as it is viewed. This may be a recording or a “live” transmission. The transcription is often verbatim. It is also commonly presented in edited form, sometimes including non-speech elements.

Various standards have been developed for including captioning information with compressed video transmitted through a communications network. CEA-708 is the standard adopted by the Advanced Television Systems Committee (ATSC) for presenting closed captioning through the digital television streams in the United States and Canada. CEA-708 was developed by the Electronic Industries Alliance. CEA-708 caption decoders are often required in the U.S. in digital televisions. Further, some broadcasters are required to caption a percentage of their broadcasts.

Depth perception for three dimensional (3D) video, also called stereoscopic video, is often provided through video compression by capturing two related but different views, one for the left eye and another for the right eye. The two views are compressed in an encoding process and sent over various networks or stored on storage media. A decoder, which may be included in a set top box, or some other device, decodes the compressed 3D video into two views and then outputs the decoded 3D video for presentation. A variety of formats are commonly used to encode or decode and then present the two views in a 3D video. Also, if depth information or disparity information from, for example, a disparity map is associated with a two dimensional (2D) view, a second view for a 3D stereoscopic display can be generated from the first view utilizing the depth or disparity information.

Encoding formats associated with the MPEG-2 and MPEG-4 standards have been used to encode 3D video. Formats associated with MPEG-4 enable the construction of bitstreams which represent more than one view of a video scene, including stereoscopic 3D video coding. However, there is no established standard which addresses the presentation of caption information in a 3D video sequence.

Caption information is 2D in nature and has no stereoscopic attributes. Thus caption information is anomalous to presentation in 3D video. This is because the 2D caption information appears out of phase with the stereoscopic objects and scenery appearing in a 3D video sequence. Therefore, when 2D caption information appears in a 3D video, it can be a distraction and have a negative impact on viewers seeking a 3D viewing experience. Those viewers which utilize the 2D caption information are thus deprived of a satisfying experience when viewing 3D video including caption information.

### BRIEF DESCRIPTION OF THE DRAWINGS

Features of the present disclosure will become apparent to those skilled in the art from the following description with reference to the figures, in which:

FIG. 1 is a system context diagram illustrating a content distribution system for 3D video, according to an example of the present disclosure;

FIG. 2 is a block diagram illustrating an encoding system and a decoding system, according to an example of the present disclosure;

FIG. 3 is a block diagram illustrating a the division of a frame disparity map into disparity regions and disparity planes, according to an example of the present disclosure;

FIG. 4 is a flow diagram illustrating an encoding method operable with the encoding system shown in FIG. 2, according to an example of the present disclosure;

FIG. 5 is a flow diagram illustrating a decoding method operable with the decoding system shown in FIG. 2, according to an example of the present disclosure; and

FIG. 6 is a block diagram illustrating a computer system to provide a platform for the encoding system and/or the decoding system shown in FIG. 2 according to examples of the present disclosure.

### SUMMARY OF THE INVENTION

According to a first principle of the invention, there is a system for encoding three dimensional (3D) information. The system may include an input terminal configured to receive a signal including frames in a 3D video sequence. The input terminal may also be configured to receive caption information to appear in a caption window associated with the frames and/or receive disparity information associated with the frames. The system may also include a processor which may be configured to determine frame disparity maps which may be based on the disparity information associated with the frames. The frame disparity maps may be determined by dividing at least a part of a frame in the frames into a plurality of grid cells in a grid. The grid cells may define a disparity measure associated with their respective grid location in the grid. A number of grid cells in the plurality may be operable to form a caption window disparity map which may be associated with the caption window. The caption window disparity map may be dividable into equivalent size portions with the portions including an equivalent amount of grid cells. The processor may also be configured to encode the frames, the caption information and the frame disparity maps.

According to a second principle of the invention, there is a method for encoding three dimensional (3D) information. The method may include receiving a signal including frames in a 3D video sequence, receiving caption information to appear in a caption window associated with the frames, and/or receiving disparity information associated with the frames. The method may also include determining, utilizing a processor, frame disparity maps which may be based on the disparity information associated with the frames. The frame disparity maps may be determined by dividing at least a part of a frame in the frames into a plurality of grid cells in a grid. The grid cells may define a disparity measure associated with their respective grid location in the grid. The number of grid cells in the plurality may be operable to form a caption window disparity map which may be associated with the caption window. The caption window disparity map may be dividable into equivalent size portions with the portions including an equivalent amount of grid cells. The method may also include encoding the frames, the caption information and the frame disparity maps.

According to a third principle of the invention, there is a non-transitory computer readable medium (CRM) storing computer readable instructions which, when executed by a computer system, performs a method for encoding three dimensional (3D) information. The method may include receiving a signal including frames in a 3D video sequence, receiving caption information to appear in a caption window associated with the frames, and/or receiving disparity information associated with the frames. The method may also include determining, utilizing a processor, frame disparity maps which may be based on the disparity information associated with the frames. The frame disparity maps may be determined by dividing at least a part of a frame in the frames into a plurality of grid cells in a grid. The grid cells may define a disparity measure associated with their respective grid location in the grid. The number of grid cells in the plurality may be operable to form a caption window disparity map which may be associated with the caption window. The caption window disparity map may be dividable into equivalent size portions with the portions including an equivalent amount of grid cells. The method may also include encoding the frames, the caption information and the frame disparity maps.

According to a fourth principle of the invention, there is a system for decoding encoded three dimensional (3D) information. The system may include an input terminal configured to receive encoded frames in a 3D video sequence, receive encoded caption information, operable to appear in a caption window, associated with the encoded frames, and/or receive encoded frame disparity maps associated with the encoded frames. The system may also include a processor configured to decode the received encoded frames, the received encoded caption information, and the received encoded frame disparity maps. The processor may also be configured to identify a location of a caption window in the decoded frames and determine caption window disparity maps utilizing the decoded frame disparity maps based on the location of the caption window in the decoded frames. The processor may also be configured to display the caption information in the caption windows utilizing the determined caption window disparity maps.

According to a fifth principle of the invention, there is a method for decoding encoded three dimensional (3D) information. The method may include receiving encoded frames in a 3D video sequence. The method may also include receiving encoded caption information, operable to appear in a caption window, associated with the encoded frames, and/or receiving encoded frame disparity maps associated with the encoded frames. The method may also include decoding, utilizing a processor, the received encoded frames, the received encoded caption information, and/or the received encoded frame disparity maps. The method may also include identifying a location of a caption window in the decoded frames. The method may also include determining caption window disparity maps utilizing the decoded frame disparity maps based on the location of the caption window in the decoded frames. The method may also include displaying the caption information in the caption windows utilizing the determined caption window disparity maps.

According to a sixth principle of the invention, there is a non-transitory computer readable medium (CRM) storing computer readable instructions which, when executed by a computer system, performs a method of decoding encoded three dimensional (3D) information. The method may include receiving encoded frames in a 3D video sequence. The method may also include receiving encoded caption information, operable to appear in a caption window, associated with the encoded frames, and/or receiving encoded frame disparity maps associated with the encoded frames. The method may also include decoding, utilizing a processor, the received encoded frames, the received encoded caption information, and/or the received encoded frame disparity maps. The method may also include identifying a location of a caption window in the decoded frames. The method may also include determining caption window disparity maps utilizing the decoded frame disparity maps based on the location of the caption window in the decoded frames. The method may also include displaying the caption information in the caption windows utilizing the determined caption window disparity maps.

According to the embodiments, there are encoding and decoding systems, methods, and computer-readable media (CRMs) for encoding and decoding three dimensional (3D) information operable to render 3D caption information in a 3D video sequence. The encoding and/or decoding of the 3D information is such that associated caption information may be rendered and/or presented in 3D within a caption window in a 3D video. By utilizing the 3D information to render the caption information in 3D within the 3D video, the caption information is not displayed as merely a two dimensional object in the 3D video sequence. This avoids the caption information appearing as a two dimensional anomaly and/or other less attractive displaying within the 3D video. Users of the 3D video are thus provided with a satisfying experience when viewing the 3D video with caption information displayed in 3D. The 3D information may be encoded and transmitted separately from the caption information. This allows for efficient processing at a receiver and the 3D information may be discarded in the event the 3D video is presented as a 2D presentation.

### DETAILED DESCRIPTION

For simplicity and illustrative purposes, the present disclosure is described by referring mainly to examples thereof. In the following description, numerous specific details are set forth in order to provide a thorough understanding of the present disclosure. It is readily apparent however, that the present disclosure may be practiced without limitation to these specific details. In other instances, some methods and structures have not been described in detail so as not to unnecessarily obscure the present disclosure. Furthermore, different examples are described below. The examples may be used or performed together in different combinations. As used herein, the term “includes” means includes but not limited to the term “including”. The term “based on” means based at least in part on.

According to examples, there are encoding and decoding systems, methods, and machine readable instructions stored on computer-readable media (CRMs) for encoding and decoding 3D information operable to render 3D caption information in a 3D video sequence. Caption information may include any information displayable in a caption window that may supplement audio or visual content. Disparity information may include any information associated with a depth or a disparity of an image or part thereof, a scene or part thereof, or an object in a scene in a frame. The disparity information may be in the form of a disparity map or it may be inherent within two separate views forming a 3D view. In addition, disparity information may be derived from a disparity map or the two views forming a 3D view.

The disparity information may include a disparity measure which describes a binocular disparity and/or depth of an object or scene at a location in the frame. Disparity measures are described in further detail below. The encoding and/or decoding of the disparity information is such that the associated caption information may be displayed and/or presented in 3D within a caption window in a 3D video. By utilizing the disparity information to display the caption information in 3D within the 3D video, the caption information does not present itself as merely two dimensional in the 3D video sequence of frames. This avoids the caption information appearing as a two dimensional anomaly and/or other less attractive displaying within the 3D video. Users of the 3D video are thus provided with a satisfying experience when viewing the 3D video with caption information displayed in 3D.

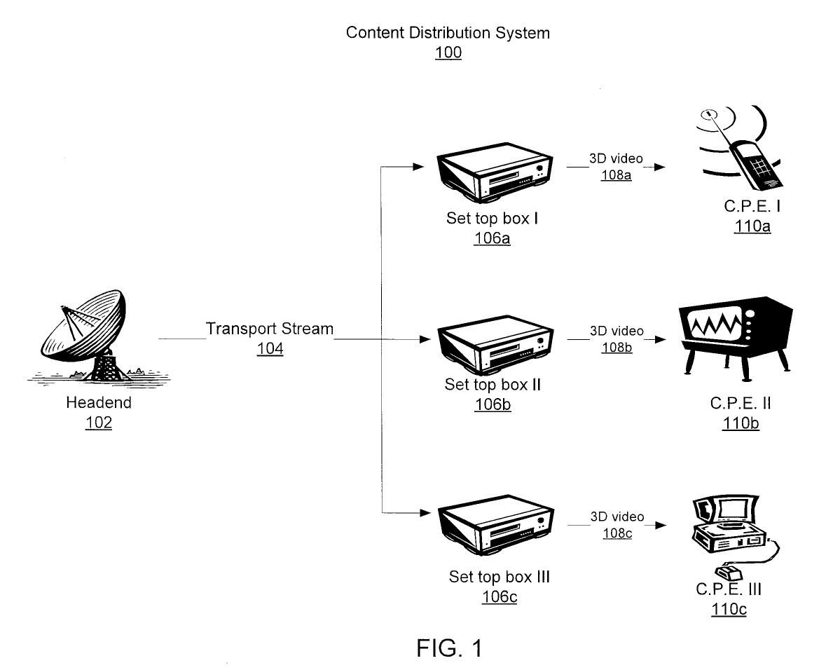

Referring to FIG. 1, there is shown a content distribution system 100 including a headend 102. At the headend, the 3D video may be encoded with associated caption information and disparity information through an encoding system. Caption information, such as caption information according to the CEA-708 standard, may be encoded with disparity information, for example, within a data stream associated with picture user data or as part of a supplemental enhancement information (SEI) information stream within a transport stream. In addition, caption information may be packaged in other parts of a transport stream or transmitted over a communications network in a message stream which is separate from a transport stream.

The headend 102 transmits a transport stream 104 which may include the encoded 3D video, the encoded caption information and the encoded disparity information to a receiver apparatus, such as set top box I 106a. At the receiver apparatus these are decoded. After decoding, the 3D video 108a with caption information may be transmitted to a client device, such as client premises equipment I 110a which is a mobile phone in this example. In like manner, set top box II 106b may transmit 3D video bitstream 108b with caption information to client premises equipment II 110b, which is a television. Also, set top box III 106c may transmit 3D video bitstream 108c with caption information in 3D to client premises equipment III 110c, which is a computer. In the instance that a legacy set top box or older television without 3D video capabilities are receiving the transmission, the disparity information is not utilized. In this circumstance, the caption information may be displayed in a conventional 2D format in a 2D video presentation.

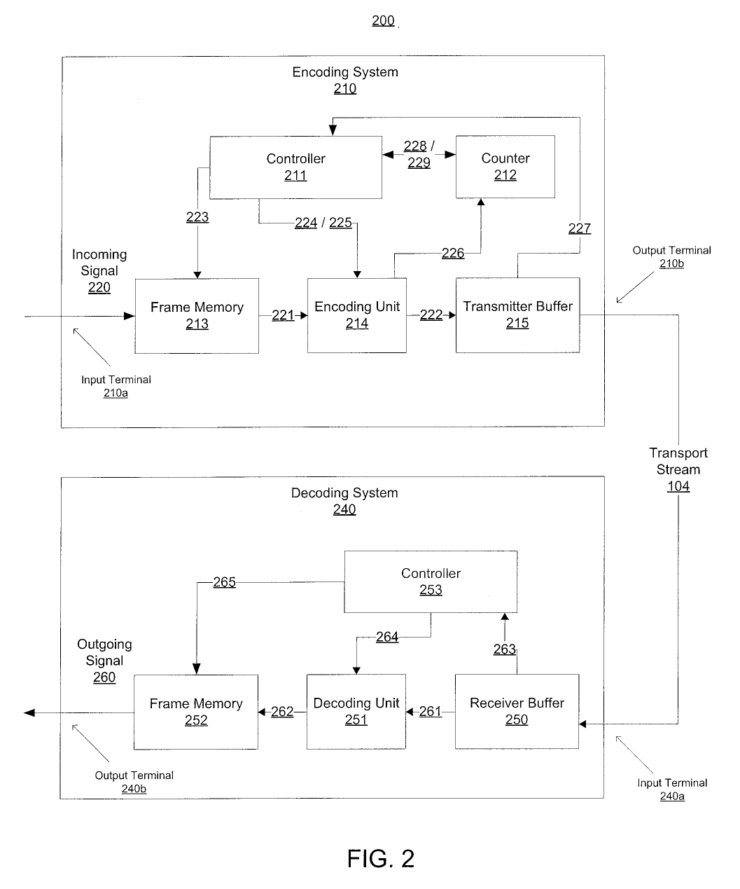

An encoding system associated with the headend 102 may encode the 3D video with associated caption information and disparity information. An example of such an encoding system is encoding system 210 shown in FIG. 2. The encoded disparity information and encoded caption information may be transmitted in the transport stream 104 to a decoding system, such as decoding system 240 in FIG. 2. The decoding system 240 may be associated with a set top box or other apparatus receiving the encoded disparity information, encoded caption information and encoded 3D video. The encoding system 210 and the decoding system 240 are explained in greater detail below.

At an encoding system which may be associated with a headend, the disparity information, incoming to the encoding system, associated with frames in a 3D video sequence and caption information may be received at the headend with a signal including the frames in the 3D video sequence. The caption information may be operable to appear in a caption window in the 3D video sequence after it is decoded and presented for viewing. The disparity information may describe or define the binocular disparity and/or the depth of objects or scenery appearing in frames of the 3D video sequence. The disparity information may be utilized to construct frame disparity maps associated with the frames in the 3D video sequence.

The frame disparity maps may then be encoded and transmitted from the headend 102 and may be transmitted with the encoded frames for the 3D video sequence and the encoded caption information. After being received at, for example, a set top box, the encoded frame disparity map is decoded and a location of a caption window on a frame disparity map is identified. According to different examples, the location and/or size of the caption window in the frame disparity map may be set by the content provider or the encoding system at the headend 102a. In another example, the location and/or size of the caption window in the frame disparity map may be set by the viewer after decoding at the set top box or through a television. The grid cells on the frame disparity map within the caption window form a caption window disparity map. The resolution of the grid cell size may be significantly smaller than the resolution associated with the 3D video image or the caption information. Hence the transmitted frame disparity map may have a smaller resolution than the transmitted image and caption information. The headend 102 may have the capability to determine and/or change the resolutions associated with the transmitted frame disparity map. The disparity information associated with the caption window disparity map may then be utilized to display the caption information in 3D for presentation in the 3D video sequence.

A frame disparity map may be constructed by dividing a frame into a grid made up of grid cells. Each grid cell is associated with a grid point location on a frame. A disparity measure is associated with each grid cell. The disparity measure may be a value or number that defines a binocular disparity and/or depth of an object or scene at a location in the frame. The disparity measure may be determined with respect to a reference point for measuring the disparity or depth associated with an object at a location in a frame. For instance, a reference point of zero actual disparity or zero actual depth may be selected. Disparity and depth are inversely related. So an object that is close-up to the viewer will have a greater disparity and/or a lower depth with respect to the viewer. As used herein, the term disparity measure refers to a value based on a disparity and/or a depth with respect to a viewer.

An object which appears farther away in a scene depicted in a frame of a 3D video will have a lower disparity measure and/or a higher depth measure. If the object appears in a grid point location in a frame map of a frame, the disparity measure associated with the object may be assigned to a grid cell associated with the grid point location. The grid cells in a frame disparity map may be non-overlapping or overlapping. If the object occupies multiple grid point locations in a frame, the disparity measure associated with the grid cells assigned to these grid point locations may be equivalent.

A frame disparity map may be defined by collections of grid cells in connected grid points in which the grid cells having equivalent disparity measures, or are all within a range of disparity measures. A disparity region is a collection of grid cells having equivalent disparity measures, or are all within a range of disparity measures. Disparity region data is information relating to the location of the grid points and the disparity measures associated with grid cells in the disparity region.

A frame disparity map may also be defined by collections of grid points with grid cells at the same depth or disparity, but are not necessarily connected. These collections include grid cells having equivalent disparity measures, or are all within a range of disparity measures. A disparity plane is a collection of grid cells having equivalent disparity measures, or are all within a range of disparity measures but is not necessarily connected. Disparity plane data is information relating to the location of the grid points and the disparity measures associated with grid cells in the disparity plane.

A frame disparity map may also be defined by planes of equal size portions, such as quadrants. After division at a plane, the grid cells in one portion or quadrant may have an equivalent disparity measure or may all be within a range of disparity measures. At that point, the quadrant or portion having cells with equivalent disparity measures is defined as a disparity region at a plane of subdivision. The remaining portions or quadrants which do not have cells all having an equivalent disparity measure (or falling with a range of disparity measures) are subdivided further at successive planes of subdivision. This process of subdividing portions or quadrants at successive planes may continue until all the grid cells in a portion or quadrant at a disparity plane have equivalent disparity measures.

A frame disparity map has a single plane before any subdivisions occur. If all the grid cells in a frame have equivalent disparity measures, then the frame has only one disparity plane and one disparity region. If the frame includes cells having different disparity measures, then the frame may be divided into multiple disparity regions at multiple disparity planes.

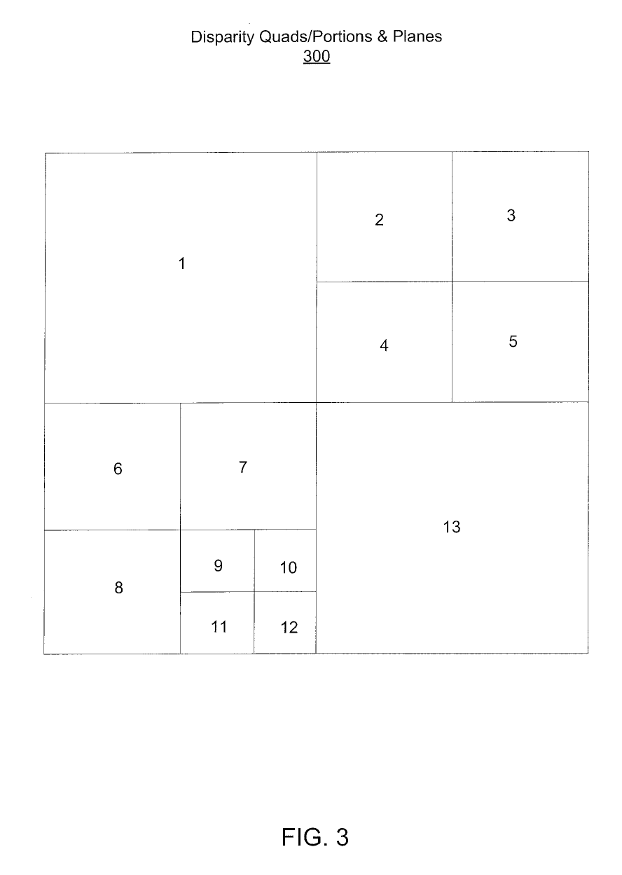

Referring to FIG. 3, when a frame disparity map is first divided into quadrants a disparity plane is formed having four quadrants. At this first subdivision disparity plane, all the grid cells in either one of Quadrant 1 and Quadrant 13 have equivalent disparity measures. However, the other quadrants at this subdivision plane do not have equivalent disparity measures associated with all their grid cells and are subdivided further at successive disparity planes.

At the next subdivision plane, all the grid cells in any one of Quadrants 2-8 have equivalent disparity measures. However, the remaining quadrant to the right of Quadrant 8, does not. This Quadrant undergoes another subdivision into another disparity plane forming Quadrants 9-12. Each of the Quadrants 1-13 is a separate disparity region. The different levels of subdivision are the different disparity planes. Data associated with the disparity regions and disparity planes may be incorporated with the frame disparity map for the frame.

The disparity information associated with a frame in a 3D video sequence is encoded as a frame disparity map. It may be encoded according to various video encoding formats, such as MPEG-2 or MPEG-4 AVC. Referring to FIG. 2, there is shown the encoding system 210 and the decoding system 240, according to an example. The decoding system 240 is representative of any of the set top boxes or other receiving devices discussed above with respect to FIG. 1. The encoding system 210 may transmit the encoded transport stream 104 to the decoding system 240, according to an example.

The encoded frame disparity map may be packaged with the encoded caption information, such as caption information according to the CEA-708 standard. These may be transmitted in an MPEG-2 transport stream within a data stream associated with MPEG-2 video picture user data. In a transport stream encoded according to the MPEG-4 AVC format, caption information with associated encoded frame disparity maps may be encoded as part of a supplemental enhancement information (SEI) information stream. In addition, caption information may be packaged in other parts of a transport stream or transmitted over a communications network in a message stream which is separate from a transport stream.

Referring again to FIG. 2, the encoding system 210 includes an input terminal 210a, a controller 211, a counter 212, a frame memory 213, an encoding unit 214, a transmitter buffer 215 and an output terminal 210b. The decoding system 240 includes a receiver buffer 250, a decoding unit 251, a frame memory 252 and a controller 253. The encoding system 210 and the decoding system 240 are coupled to each other via a transmission path including the transport stream 104. The controller 211 of the encoding system 210 controls the amount of data to be transmitted on the basis of the capacity of the receiver buffer 250 and may include other parameters such as the amount of data per a unit of time. The controller 211 controls the encoding unit 214, to prevent the occurrence of a failure of a received signal decoding operation of the decoding system 240. The controller 211 may include, for example, a microcomputer having a processor, a random access memory and a read only memory.

An incoming signal 220 supplied from, for example, a content provider may include the frames in the 3D video sequence, the caption information and the disparity information. Frame disparity maps may be derived from the disparity information, utilizing the controller 211. The frame memory 213 has a first area used for storing the incoming disparity information, the caption information and the frames in the 3D video sequence from the incoming signal 220 and a second area is used for reading out the stored data and outputting it to the encoding unit 214. The controller 211 outputs an area switching control signal 223 to the frame memory 213. The area switching control signal 223 indicates whether the first area or the second area is to be used.

The controller 211 outputs an encoding control signal 224 to the encoding unit 214. The encoding control signal 224 causes the encoding unit 214 to start an encoding operation. In response to the encoding control signal 224 from the controller 211, including control information such as caption information and disparity data associated with the frames, the encoding unit 214 starts to read out the video signal to a high-efficiency encoding process, such as an interframe coding process or a discrete cosine transform to encode frames in the 3D video, the caption information and to prepare the frame disparity maps and encode them.

The encoding unit 214 may prepare an encoded video signal 222 in a packetized elementary stream (PES) including video packets and program information packets. The encoding unit 214 may map the video access units into video packets using a program time stamp (PTS) and the control information. The PTS and the control information may also be associated with the program information packet 170 which is associated with a corresponding video packet 160.

The encoded video signal 222 is stored with the encoded caption information and encoded frame disparity maps in the transmitter buffer 214. The information amount counter 212 is incremented to indicate the amount of data in the transmitted buffer 215. As data is retrieved and removed from the buffer, the counter 212 is decremented to reflect the amount of data in the buffer. The occupied area information signal 226 is transmitted to the counter 212 to indicate whether data from the encoding unit 214 has been added or removed from the transmitted buffer 215 so the counter 212 can be incremented or decremented. The controller 211 controls the production of packets produced by the encoding unit 214 on the basis of the occupied area information 226 communicated in order to prevent an overflow or underflow from taking place in the transmitter buffer 215.

The information amount counter 212 is reset in response to a preset signal 228 generated and output by the controller 211. After the information counter 212 is reset, it counts data output by the encoding unit 214 and obtains the amount of information which has been generated. Then, the information amount counter 212 supplies the controller 211 with an information amount signal 229 representative of the obtained amount of information. The controller 211 controls the encoding unit 214 so that there is no overflow at the transmitter buffer 215.

The decoding system 240 includes an input terminal 240a, a receiver buffer 250, a controller 253, a frame memory 252, a decoding unit 251 and an output terminal 240b. The receiver buffer 250 of the decoding system 240 may temporarily store the PES with encoded frames, encoded caption information and encoded frame disparity maps received from the encoding system 210 via the transport stream 104. The decoding system 240 counts the number of frames of the received data, and outputs a frame number signal 263 which is applied to the controller 253. The controller 253 supervises the counted number of frames at a predetermined interval, for instance, each time the decoding unit 251 completes the decoding operation.

When the frame number signal 263 indicates the receiver buffer 250 is at a predetermined capacity, the controller 253 outputs a decoding start signal 264 to the decoding unit 251. When the frame number signal 263 indicates the receiver buffer 250 is at less than a predetermined capacity, the controller 253 waits for the occurrence of the situation in which the counted number of frames becomes equal to the predetermined amount. When the frame number signal 263 indicates the receiver buffer 250 is at the predetermined capacity, the controller 253 outputs the decoding start signal 264. The encoded frames, caption information and frame disparity maps are decoded in a monotonic order (i.e., increasing or decreasing) based on a presentation time stamp (PTS) in the header of the program information packets.

In response to the decoding start signal 264, the decoding unit 251 decodes data amounting to one frame, an associated frame disparity map and captioning information from the receiver buffer 250. The caption window disparity map is determined using an identified location of the caption window in the frame and the frame disparity map. The caption information is displayed in 3D within the caption window in the decoded frame of the 3D video sequence. Utilizing the 3D video and the 3D caption information, the decoding unit 251 writes a decoded video signal 262 into the frame memory 252. The frame memory 252 has a first area into which the decoded video signal is written, and a second area used for reading out the decoded video data and outputting it to a monitor or the like.

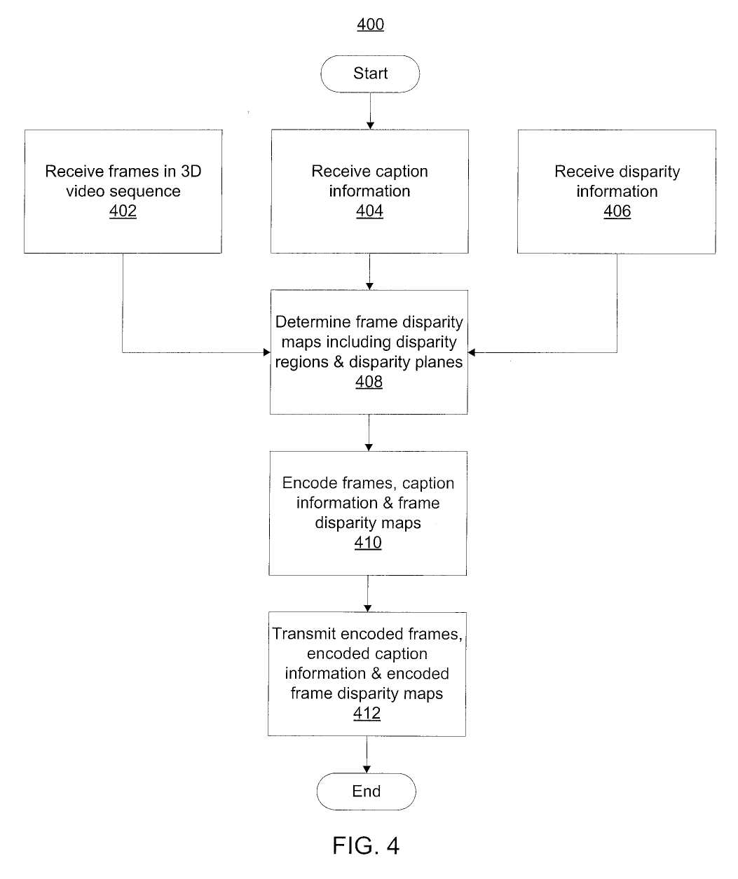

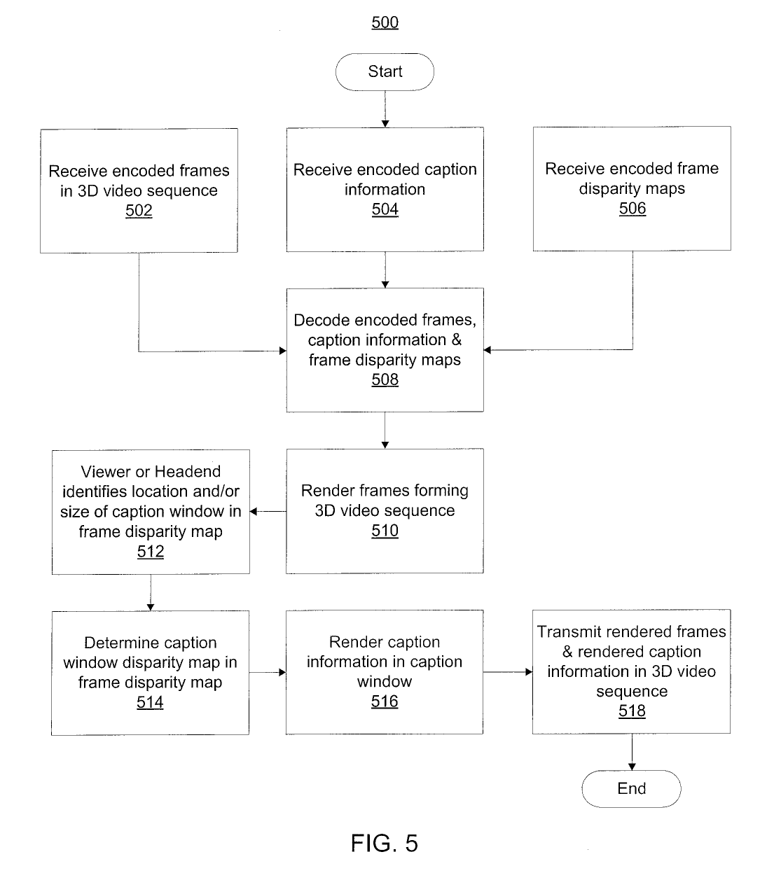

According to different examples, the encoding system 210 may be incorporated or otherwise associated with the headend 102 and the decoding system 240 may be incorporated or otherwise associated with a set top box, such as set top box I 106a. These may be utilized separately or together in methods of encoding and/or decoding disparity information associated with caption information in a 3D video sequence. Various manners in which the encoding system 210 and the decoding system 240 may be implemented are described in greater detail below with respect to FIGS. 4 and 5, which depict flow diagrams of methods 400 and 500.

Method 400 is a method of encoding disparity information associated with a 3D video sequence. Method 500 is a method of decoding the disparity information associated with the 3D video sequence. It is apparent to those of ordinary skill in the art that the methods 400 and 500 represent generalized illustrations and that other blocks may be added or existing blocks may be removed, modified or rearranged without departing from the scopes of the methods 400 and 500. The descriptions of the methods 400 and 500 are made with particular reference to the encoding system 210 and the decoding system 240 depicted in FIG. 2. It should, however, be understood that the methods 400 and 500 may be implemented in systems and/or devices which differ from the encoding system 210 and the decoding system 240 without departing from the scopes of the methods 400 and 500.

With reference to the method 400 in FIG. 4, at block 402, the encoding system 210 receives information for a 3D video sequence at the frame memory 213. For example, the received information may be uncompressed frames in a video bitstream for two separate views or uncompressed frames for a single view with an associated disparity map which may be utilized to generate a second view from the first view.

At block 404, the encoding system 210 receives the caption information. The caption information is to appear in a caption window associated with the frames.

At block 406, the encoding system 210 receives the disparity information associated with the frames.

At block 408, the encoding system 210 may determine frame disparity maps associated with the frames. The controller 211 in the encoding system 210 may determine the frame disparity maps by dividing at least a part of a frame into a plurality of grid cells in a grid associated with the frame. The grid cells define a disparity measure associated with their respective grid location in the grid. A number of grid cells in the plurality are operable to form a caption window disparity map associated with the caption window. The caption window disparity map is dividable into equivalent size portions with the portions including an equivalent amount of grid cells.

The controller 211 in the encoding system 210 may also determine disparity region data and disparity plane data based on the frame disparity maps. These may be determined at the controller 211 by identifying a number of disparity regions associated with a number of disparity planes. These are determined by dividing an area of a frame disparity map into at least one disparity region associated with at least one disparity plane and the grid cells within the at least one disparity region on the at least one disparity plane have an equivalent disparity measure. The disparity region data and the disparity plane data may be incorporated into the frame disparity maps.

At block 410, the encoding unit 214 in the encoding system 210 may encode the frames, the caption information and the frame disparity maps.

At block 412, the transmitter buffer 215 in the encoding system 210 transmits the encoded frames, the encoded caption information and the encoded frame disparity maps.

With reference to the method 500 in FIG. 5, at block 502, the decoding system 240 receives the encoded frames in the 3D video sequence at the receiver buffer 250.

At block 504, the decoding system 240 receives the encoded caption information, operable to appear in a caption window, associated with the encoded frames at the receiver buffer 250.

At block 506, the decoding system 240 receives the encoded frame disparity maps associated with the encoded frames at the receiver buffer 250.

At block 508, the decoding unit 251 in the decoding system 240 decodes the received encoded frames, the received encoded caption information, and the received encoded frame disparity maps. The decoding unit 251 may operate in conjunction with the controller 253.

At block 510, the controller 253 in the decoding system 240 decodes the frames forming the 3D video sequence.

At block 512, the controller 253 in the decoding system 240 may identify a location of a caption window in the decoded frames. The location of the caption window in the decoded frames may also be incorporated in the caption information and read utilizing the controller 253. According to different examples, the location and/or size of the caption window in the frame disparity map may be set by the content provider or the encoding system at the headend 102a. In another example, the location and/or size of the caption window in the frame disparity map may be set by the viewer after decoding at the set top box or through a television.

At block 514, the controller 253 in the decoding system 240 determines the caption window disparity maps utilizing the frame disparity maps, based on the location of the caption window in the decoded frames.

At block 516, the controller 253 in the decoding system 240 displays the caption information in the caption windows utilizing the caption window disparity maps.

At block 518, the decoding system 240 transmits a signal including the decoded frames and decoded caption information in the 3D video sequence from the frame memory 252.

Some or all of the methods and operations described above may be provided as machine readable instructions, such as a utility, a computer program, etc., stored on a computer readable storage medium, which may be non-transitory such as hardware storage devices or other types of storage devices. For example, they may exist as MRIS program(s) comprised of program instructions in source code, object code, executable code or other formats.

An example of a computer readable storage media includes a conventional computer system RAM, ROM, EPROM, EEPROM, and magnetic or optical disks or tapes. Concrete examples of the foregoing include distribution of the programs on a CD ROM. It is therefore to be understood that any electronic device capable of executing the above-described functions may perform those functions enumerated above.

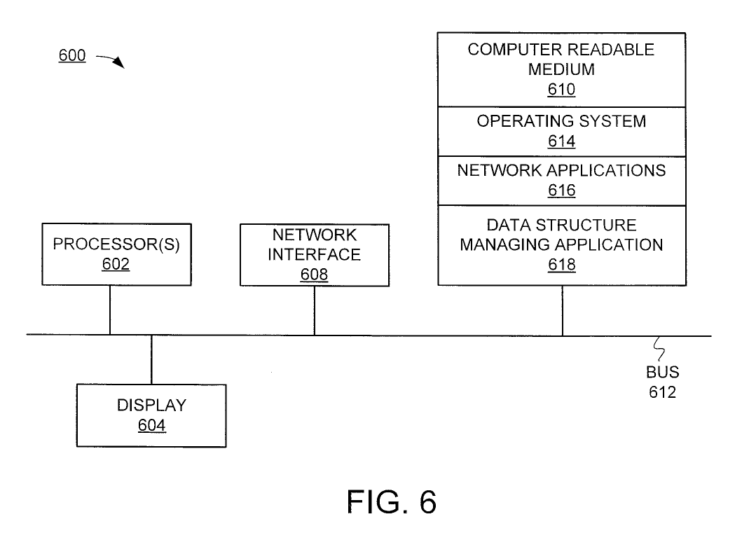

Turning now to FIG. 6, there is shown a computing device 600, which may be employed as a platform in an encoding system, such as encoding system 210 or a decoding system, such as decoding system 240, for implementing or executing the methods depicted in FIG. 4 and FIG. 5, or code associated with the methods. It is understood that the illustration of the computing device 600 is a generalized illustration and that the computing device 600 may include additional components and that some of the components described may be removed and/or modified without departing from a scope of the computing device 600.

The device 600 includes a processor 602, such as a central processing unit; a display device 604, such as a monitor; a network interface 608, such as a Local Area Network (LAN), a wireless 802.11x LAN, a 3G or 4G mobile WAN or a WiMax WAN; and a computer-readable medium 610. Each of these components may be operatively coupled to a bus 612. For example, the bus 612 may be an EISA, a PCI, a USB, a FireWire, a NuBus, or a PDS.

The computer readable medium 610 may be any suitable medium that participates in providing instructions to the processor 602 for execution. For example, the computer readable medium 610 may be non-volatile media, such as an optical or a magnetic disk; volatile media, such as memory; and transmission media, such as coaxial cables, copper wire, and fiber optics. Transmission media can also take the form of acoustic, light, or radio frequency waves. The computer readable medium 610 may also store other MRIS applications, including word processors, browsers, email, instant messaging, media players, and telephony MRIS.

The computer-readable medium 610 may also store an operating system 614, such as MAC OS, MS WINDOWS, UNIX, or LINUX; network applications 616; and a data structure managing application 618. The operating system 614 may be multi-user, multiprocessing, multitasking, multithreading, real-time and the like. The operating system 614 may also perform basic tasks such as recognizing input from input devices, such as a keyboard or a keypad; sending output to the display 604 and the design tool 606; keeping track of files and directories on medium 610; controlling peripheral devices, such as disk drives, printers, image capture device; and managing traffic on the bus 612. The network applications 616 includes various components for establishing and maintaining network connections, such as MRIS for implementing communication protocols including TCP/IP, HTTP, Ethernet, USB, and FireWire.

The data structure managing application 618 may provides various MRIS components for building/updating an architecture, such as architecture 600, for a non-volatile memory, as described above. In certain examples, some or all of the processes performed by the application 618 may be integrated into the operating system 614. In certain examples, the processes may be at least partially implemented in digital electronic circuitry, in computer hardware, firmware, MRIS, or in any combination thereof.

According to examples, there are encoding and decoding systems, methods, and computer-readable media (CRMs) for encoding and decoding 3D information operable to display 3D caption information in a 3D video sequence. The encoding and/or decoding of the 3D information, such as disparity information, is such that the associated caption information may be displayed and/or presented in 3D within a caption window in a 3D video. By utilizing the disparity information to display the caption information in 3D within the 3D video, the caption information does not present itself as merely two dimensional in the 3D video sequence. This avoids the caption information appearing as a two dimensional anomaly and/or other less attractive displaying within the 3D video. Users of the 3D video are thus provided with a satisfying experience when viewing the 3D video with caption information displayed in 3D. The disparity information may be encoded and transmitted separately from the caption information. This allows for efficient processing at a receiver and discarded in the event the 3D video is presented as a 2D presentation.

Although described specifically throughout the entirety of the instant disclosure, representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the examples. While the examples have been described with reference to examples, those skilled in the art are able to make various modifications to the described examples without departing from the scope of the examples as described in the following claims, and their equivalents.

What is claimed is:

1. A system for encoding three dimensional (3D) information, the system comprising:
an input terminal configured to
receive a signal including frames in a 3D video sequence;
receive caption information to appear in a caption window associated with the frames;
receive disparity information associated with the frames;
a processor configured to
determine frame disparity maps based on the disparity information associated with the frames,
wherein the frame disparity maps are determined by dividing at least a part of a frame in the frames into a plurality of grid cells in a grid, the grid cells defining a disparity measure associated with their respective grid location in the grid, and
wherein a number of grid cells in the plurality are operable to form a caption window disparity map associated with the caption window, the caption window disparity map being dividable into equivalent size portions with the portions including an equivalent amount of grid cells; and
encode the frames, the caption information and the frame disparity maps.

2. The system of claim 1, wherein the processor is configured to
determine disparity region data and disparity plane data including
determining a number of disparity regions associated with a number of disparity planes including
dividing an area of a frame disparity map into at least one disparity region associated with at least one disparity plane
wherein the grid cells within the at least one disparity region on the at least one disparity plane have an equivalent disparity measure; and
incorporate the determined disparity region data and the disparity plane data into the frame disparity maps.

3. A method for encoding three dimensional (3D) information, the method comprising:
receiving a signal including frames in a 3D video sequence;
receiving caption information to appear in a caption window associated with the frames;
receiving disparity information associated with the frames;
determining, utilizing a processor, frame disparity maps based on the disparity information associated with the frames,
wherein the frame disparity maps are determined by dividing at least a part of a frame in the frames into a plurality of grid cells in a grid, the grid cells defining a disparity measure associated with their respective grid location in the grid, and
wherein a number of grid cells in the plurality are operable to form a caption window disparity map associated with the caption window, the caption window disparity map being dividable into equivalent size portions with the portions including an equivalent amount of grid cells; and
encoding the frames, the caption information and the frame disparity maps.

4. The method of claim 3, the method further comprising
determining disparity region data and disparity plane data including
determining a number of disparity regions associated with a number of disparity planes including
dividing an area of a frame disparity map into at least one disparity region associated with at least one disparity plane
wherein the grid cells within the at least one disparity region on the at least one disparity plane have an equivalent disparity measure; and
incorporating the determined disparity region data and the disparity plane data into the frame disparity maps.

5. The method of claim 3, wherein the transmitted encoded frame disparity maps are packaged in one of picture user data and supplemental enhancement information (SEI) in a transmitted transport stream.

6. The method of claim 3, wherein the transmitted encoded frame disparity maps are packaged separately from the transmitted caption information in a transmitted transport stream.

7. The method of claim 3, wherein the caption window disparity map is dividable into equivalent size quadrants including an equivalent amount of grid cells.

8. The method of claim 3, wherein a quadrant of the caption window disparity map is dividable into equivalent size quadrants including an equivalent amount of grid cells.

9. A non-transitory computer readable medium (CRM) storing computer readable instructions which, when executed by a computer system, perform a method for encoding three dimensional (3D) information, the method comprising:
receiving a signal including frames in a 3D video sequence;
receiving caption information to appear in a caption window associated with the frames;
receiving disparity information associated with the frames;
determining, utilizing a processor, frame disparity maps based on the disparity information associated with the frames,
wherein the frame disparity maps are determined by dividing at least a part of a frame in the frames into a plurality of grid cells in a grid, the grid cells defining a disparity measure associated with their respective grid location in the grid, and
wherein a number of grid cells in the plurality are operable to form a caption window disparity map associated with the caption window, the caption window disparity map being dividable into equivalent size portions with the portions including an equivalent amount of grid cells; and
encoding the frames, the caption information and the frame disparity maps.

10. The CRM of claim 9, the method further comprising
determining disparity region data and disparity plane data including
determining a number of disparity regions associated with a number of disparity planes including
dividing an area of a frame disparity map into at least one disparity region associated with at least one disparity plane
wherein the grid cells within the at least one disparity region on the at least one disparity plane have an equivalent disparity measure; and
incorporating the determined disparity region data and the disparity plane data into the frame disparity maps.

11. A system for decoding encoded three dimensional (3D) information, the system comprising:
an input terminal configured to
receive encoded frames in a 3D video sequence;
receive encoded caption information, operable to appear in a caption window, associated with the encoded frames;
receive encoded frame disparity maps associated with the encoded frames;
a processor configured to
decode the received encoded frames, the received encoded caption information, and the received encoded frame disparity maps;
identify a location of a caption window in the decoded frames;
determine caption window disparity maps utilizing the decoded frame disparity maps based on the location of the caption window in the decoded frames; and
display the caption information in the caption windows utilizing the determined caption window disparity maps.

12. The system of claim 11, wherein the processor is configured to decode the encoded frame disparity maps including incorporated disparity region data and disparity plane data obtained by
determining a number of disparity regions associated with a number of disparity planes by
dividing an area of a frame disparity map into at least one disparity region associated with at least one disparity plane and the grid cells within the at least one disparity region on the at least one disparity plane have an equivalent disparity measure.

13. A method for decoding encoded three dimensional (3D) information, the method comprising:
receiving encoded frames in a 3D video sequence;
receiving encoded caption information, operable to appear in a caption window, associated with the encoded frames;
receiving encoded frame disparity maps associated with the encoded frames;
decoding, utilizing a processor, the received encoded frames, the received encoded caption information, and the received encoded frame disparity maps;
identifying a location of a caption window in the decoded frames;
determining caption window disparity maps utilizing the decoded frame disparity maps based on the location of the caption window in the decoded frames; and
displaying the caption information in the caption windows utilizing the determined caption window disparity maps.

14. The method of claim 13, wherein the encoded frame disparity maps include incorporated disparity region data and disparity plane data obtained by
determining a number of disparity regions associated with a number of disparity planes by
dividing an area of a frame disparity map into at least one disparity region associated with at least one disparity plane and the grid cells within the at least one disparity region on the at least one disparity plane have an equivalent disparity measure.

15. The method of claim 13, wherein the received encoded frame disparity maps are packaged in one of picture user data and supplemental enhancement information (SEI) in a received transport stream.

16. The method of claim 13, wherein the received encoded frame disparity maps are packaged separately from the received caption information in a received transport stream.

17. The method of claim 13, wherein the caption window disparity map is dividable into equivalent quadrants including an equivalent amount of grid cells.

18. The method of claim 13, wherein a quadrant of the caption window disparity map is dividable into equivalent quadrants including an equivalent amount of grid cells.

19. A non-transitory computer readable medium (CRM) storing computer readable instructions which, when executed by a computer system, perform a method of decoding encoded three dimensional (3D) information, the method comprising:
receiving encoded frames in a 3D video sequence;
receiving encoded caption information, operable to appear in a caption window, associated with the encoded frames;
receiving encoded frame disparity maps associated with the encoded frames;
decoding, utilizing a processor, the received encoded frames, the received encoded caption information, and the received encoded frame disparity maps;
identifying a location of a caption window in the decoded frames;
determining caption window disparity maps utilizing the frame disparity maps based on the location of the caption window in the decoded frames; and
displaying the caption information in the caption windows utilizing the determined caption window disparity maps.

20. The CRM of claim 19, wherein the encoded frame disparity maps include incorporated disparity region data and disparity plane data obtained by
determining a number of disparity regions associated with a number of disparity planes by
dividing an area of a frame disparity map into at least one disparity region associated with at least one disparity plane and the grid cells within the at least one disparity region on the at least one disparity plane have an equivalent disparity measure.
